(19) United States
(12) Patent Application Publication
(10) Pub. No.: US 2024/0136592 A1
(43) Pub. Date: Apr. 25, 2024

(54) SECONDARY BATTERY

(71) Applicant: SAMSUNG SDI CO., LTD., Yongin-si (KR)

(72) Inventor: Hyeong Gu ROH, Yongin-si (KR)

(21) Appl. No.: 18/469,753

(22) Filed: Sep. 18, 2023

(30) Foreign Application Priority Data
Oct. 18, 2022 (KR) 10-2022-0134812

(51) Int. Cl. H01M 10/0583; H01M 50/46

(52) U.S. Cl. CPC H01M 10/0583; H01M 50/461

(57) ABSTRACT

A secondary battery includes: an electrode assembly including: a plurality of first electrode plates and second electrode plates; and a separator folded in a zigzag form and interposed between each of the first and second electrode plates; and a case accommodating the electrode assembly, wherein at least one surface of a first electrode plate from among the first electrode plates or a second electrode plate from among the second electrode plates adheres to the separator by an adhesive solution.

### CROSS-REFERENCE TO RELATED APPLICATION

The present application claims priority to and the benefit of Korean Patent Application No. 10-2022-0134812 filed on Oct. 19, 2022, in the Korean Intellectual Property Office, the entire disclosure of which is incorporated herein by reference.

### BACKGROUND

### 1. Field

Aspects of some embodiments of the present disclosure relate to a secondary battery with relatively improved stacking stability of stacked cells.

### 2. Description of the Related Art

In general, a secondary battery may include an electrode assembly provided with a positive electrode, a negative electrode, and a separator interposed between the positive electrode and the negative electrode, and a case accommodating the electrode assembly together with an electrolyte. In the case of the electrode assembly, a plurality of unit electrode bodies are stacked or wound. The electrode assembly that is generally stacked is defined as a stack cell, and the electrode assembly that is wound in the form of a roll is defined as a jelly roll.

In the method for stacking the electrode assembly, a so-called “Z-stack” method is a method in which a separator is bent in the form of a zigzag, and a positive electrode plate and a negative electrode plate are alternately inserted between the bent portions of the separator.

However, in the process of transferring or inserting the Z-stack type electrode assembly into a case, a limitation in which an alignment state or a stacked shape is distorted is likely to occur. Therefore, it is desirable to solve the above limitation.

The above information disclosed in this Background section is only for enhancement of understanding of the background and therefore the information discussed in this Background section does not necessarily constitute prior art.

### SUMMARY

Aspects of some embodiments of the present disclosure provide a secondary battery having relatively improved stacking stability of a stack cell.

According to some embodiments, a secondary battery includes: an electrode assembly including a plurality of first electrode plates and second electrode plates, and a separator folded in a zigzag form and interposed between each of the first electrode plate and each of the second electrode plate; and a case accommodating the electrode assembly, wherein at least one surface of the first electrode plate or the second electrode plate adheres to the separator by an adhesive solution.

According to some embodiments, the adhesive solution may be sprayed to surfaces of the first electrode plate and the second electrode plate.

According to some embodiments, the adhesive solution may be sprayed to both surfaces of each of the first electrode plate and the second electrode plate.

According to some embodiments, the adhesive solution may include a polyolefin-based resin.

### BRIEF DESCRIPTION OF THE DRAWINGS

The accompanying drawings are included to provide a further understanding of the present disclosure, and are incorporated in and constitute a part of this specification. The drawings illustrate aspects of some embodiments of the present disclosure and, together with the description, serve to explain principles of the present disclosure. In the drawings:

FIG. 1 illustrates a perspective view of a secondary battery according to some embodiments;

FIG. 2 illustrates a plan view of an electrode assembly according to some embodiments;

FIG. 3 illustrates a schematic view of some processes of manufacturing a stack cell of FIG. 2 according to some embodiments;

FIG. 4 illustrates a schematic view of a manufacturing process after the manufacturing process of FIG. 3 according to some embodiments; and

FIG. 5 illustrates a schematic side view of a shape after the stack cell of FIGS. 3 and 4 is completely manufactured according to some embodiments.

### DETAILED DESCRIPTION

Embodiments according to the present disclosure may, however, be embodied in many different forms and should not be construed as being limited to the embodiments set forth herein; rather, these embodiments are provided so that those skilled in the art will more thoroughly understand the embodiments according to the present disclosure. Rather, these embodiments are provided so that this disclosure will be more thorough and more complete, and will more fully convey aspects of some embodiments of the present disclosure to those skilled in the art.

In addition, in the following drawings, the thickness or size of each layer is exaggerated for convenience and clarity of description, and the same reference numerals in the drawings refer to the same elements. As used herein, the term “and/or” includes any and all combinations of one or more of the associated listed items. In this specification, it will also be understood that if a member A is referred to as being connected to a member B, the member A can be directly connected to the member B or indirectly connected to the member B with a member B therebetween.

The terms used in this specification are for illustrative purposes of the present disclosure only and should not be construed to limit the meaning or the scope of the present disclosure. As used in this specification, a singular form may, unless definitely indicating a particular case in terms of the context, include a plural form. Also, the expressions “comprise/include” and/or “comprising/including” used in this specification neither define the mentioned shapes, numbers, steps, operations, members, elements, and/or groups of these, nor exclude the presence or addition of one or more other different shapes, numbers, steps, operations, members, elements, and/or groups of these, or addition of these. The term “and/or” used herein includes any and all combinations of one or more of the associated listed items.

As used herein, terms such as “first,” “second,” etc. are used to describe various members, components, areas, layers, and/or portions. However, it is obvious that the members, components, areas, layers, and/or portions should not be defined by these terms. The terms do not mean a particular order, up and down, or superiority, and are used only for distinguishing one member, component, area, layer, or portion from another member, component, area, layer, or portion. Thus, a first member, component, area, layer, or portion which will be described may also refer to a second member, component, area, layer, or portion, without departing from the teaching of the present disclosure.

Spatially relative terms, such as “below”, “beneath”, “lower”, “above”, “upper” and the like, may be used herein for ease of description to describe one element or feature's relationship to another element(s) or feature(s) as illustrated in the figures. These spatially relative terms are intended for easy comprehension of the prevent invention according to various process states or usage states of the prevent invention, and thus, the present disclosure is not limited thereto. For example, an element or feature shown in the drawings is turned inside out, the element or feature described as “beneath” or “below” may change into “above” or “upper”. Thus, the term “lower” may encompass the term “upper” or “below”.

Hereinafter, a secondary battery according to some embodiments of the present disclosure will be described in more detail with reference to the accompanying drawings.

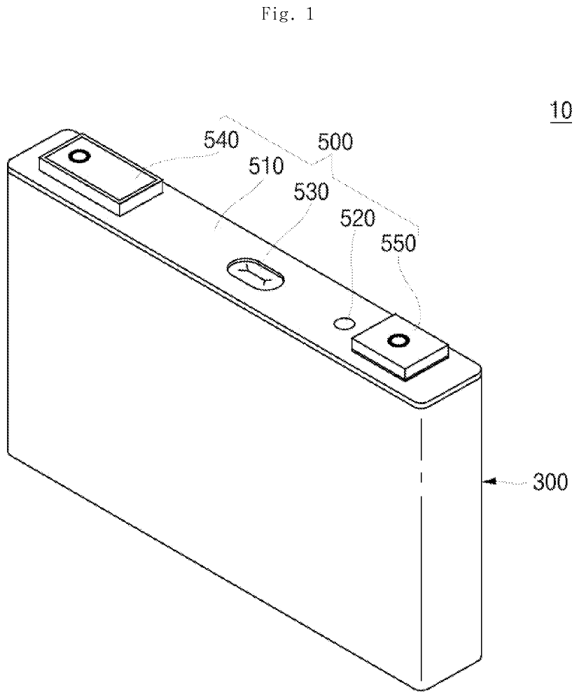

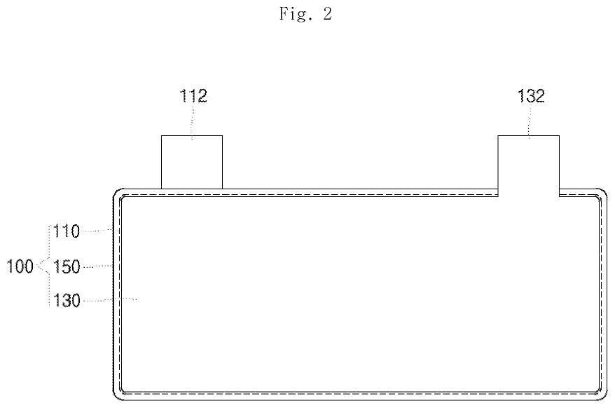

FIG. 1 illustrates a perspective view of an example of a secondary battery according to some embodiments. FIG. 2 illustrates a plan view of an example of an electrode assembly according to some embodiments.

Referring to FIGS. 1 and 2, an example secondary battery 10 according to some embodiments of the present disclosure may include an electrode assembly 100, a case 300 accommodating (e.g., housing) the electrode assembly 100 together with an electrolyte, and a cap assembly 500 sealing or closing an opening of the case 300. According to some embodiments, referring to FIG. 1, the secondary battery 10 has a rectangular parallelepiped shape (one-sided prismatic battery) as an example. However, embodiments of the present disclosure may not be limited the type or shape of the secondary battery 10 illustrated in FIG. 1, and the shape of the secondary battery 10 may be any suitable shape capable of being stacked and may be, for example, a pouch-type battery structure.

Referring to FIG. 1, the example case 300 may have a substantially rectangular parallelepiped shape, and a top surface in a long side direction (a surface having a narrow upper side in FIG. 1) may have an opening or cavity formed therein. For example, a peripheral portion of the case 300 to which the cap assembly 500 of FIG. 1 is coupled may be a substantially opened portion. That is, the opening of the case 300 may be filed or closed by the cap assembly 500. After the electrode assembly 100 and the electrolyte are accommodated or inserted into the case 300 through opened portion, the cap assembly 500 may be coupled to the case 300 at the opened portion of the case 300 to seal the case 300. The case 300 may be formed of a conductive metal such as aluminum, aluminum alloy, or steel plated with nickel. A secondary battery in which the case 300 has a substantially hexahedral shape is also referred to as a prismatic battery.

Referring to FIGS. 2, 4, and 5, the electrode assembly 100 may include one or more first electrode plates 110, one or more second electrode plates 130, and a separator 150. If the first electrode plate 110 is a positive electrode, for example, a positive electrode active material layer may be arranged or formed on each of both opposing major surfaces thereof, and if the first electrode plate 110 is a negative electrode, for example, a negative electrode active material layer may be arranged or formed on each of both opposing major surfaces thereof. If the first electrode plate 110 is a positive electrode, the second electrode plate 130 may be a negative electrode, and if the first electrode plate 110 is a positive electrode, the second electrode plate 130 may be a negative electrode. Here, an embodiment in which the first electrode plate 110 acts as the negative electrode will be described as an example, but embodiments according to the present disclosure are not limited thereto, and in some embodiments, the first electrode plate 110 may be a positive electrode and the second electrode plate 130 may be a negative electrode.

The first electrode plate 110 may be provided by applying or coating an active material such as graphite or carbon on a substrate made of metal foil such as copper, a copper alloy, nickel, or a nickel alloy. A non-coating portion on which the active material is not applied may be provided on the first electrode plate 110. The first electrode plate 110 may include a first electrode tab 112 that is a negative electrode tab extending from the non-coating portion by a length (e.g., a set or predetermined length) in one direction.

The second electrode plate 130 may be provided by applying or coating an active material such as transition metal oxide on a substrate made of metal foil such as aluminum or an aluminum alloy. A non-coating portion on which the active material is not applied may be provided on the second electrode plate 130. The second electrode plate 130 may include a second electrode tab 132 that is a positive electrode tab extending from the non-coating portion by a length (e.g., a set or predetermined length) in one direction.

The separator 150 may be interposed between the first electrode plate 110 and the second electrode plate 130 to prevent or reduce instances of short circuit between the first and second electrode plates 110 and 130 and allow lithium ions to move. The separator 150 may be made of polyethylene, polypropylene, or a composite film of polyethylene and polypropylene, but embodiments according to the present disclosure are not limited thereto.

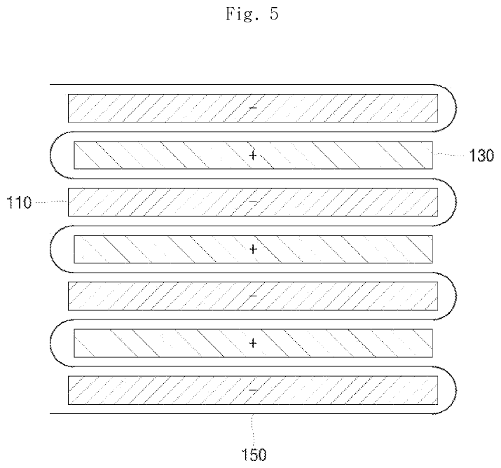

Referring to FIG. 5 to be described in more detail later, the separator 150 may have a shape that is repeatedly bent or folded in a ‘Z’ shape if viewed from the side. The above-described first and second electrode plates 110 and 130 may be alternately inserted between the zigzag-folded separators 150.

In some embodiments, the stack-type electrode assembly 100 manufactured by repeating the above-described processes may be defined as a ‘stack cell’ (the process of manufacturing the stack cell will be described in more detail later). The stack cell, which is provided as described above, may be accommodated in the case 300 together with the electrolyte, and then, the case 300 may be sealed by the cap assembly 500.

Referring to FIG. 1, the cap assembly 500 may be coupled to the case 300 in the state in which the electrode assembly 100 is accommodated in the case 300. The cap assembly 500 may include a cap plate 510 that seals an opening of the case 300, a stopper 520 that seals an electrolyte spraying port, a safety vent 530 that is ruptured if an internal gas is discharged to serve as a gas discharge passage, and first and second terminals 540 and 550 electrically connecting the first electrode tab 112 to the second electrode tab 132. The cap plate 510 may be made of the same material as the case 300 and may be coupled to the case 300 by laser welding or the like. The case 300 may be sealed by the cap plate 510 to complete the secondary battery 10.

Hereinafter, some processes in the above-described process of manufacturing the stack cell will be described in more detail.

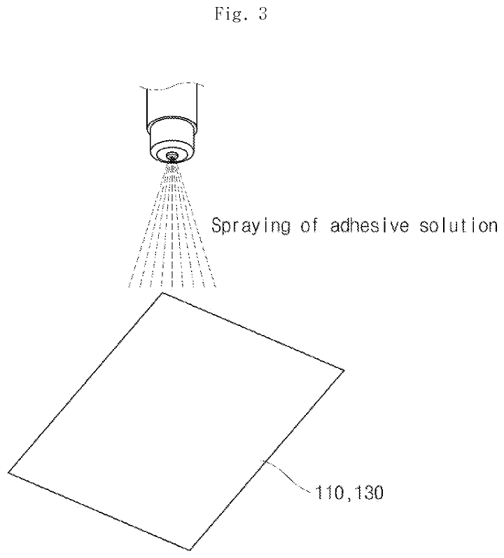

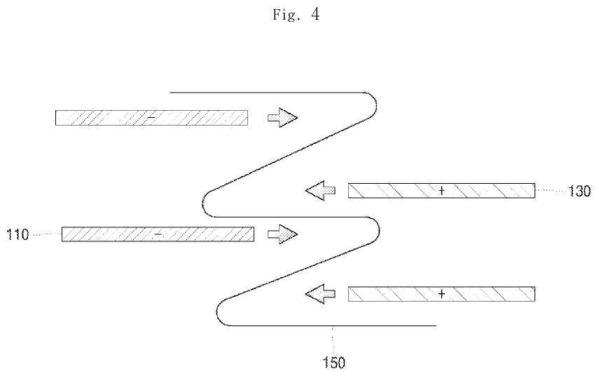

FIG. 3 illustrates a schematic view of some processes of manufacturing the stack cell of FIG. 2. FIG. 4 illustrates a schematic view of a manufacturing process after the manufacturing process of FIG. 3. FIG. 5 illustrates a schematic side view of a shape after the stack cell of FIGS. 3 and 4 is completely manufactured.

Referring to FIG. 3, to form a stack cell by stacking the electrode assemblies 100, an adhesive solution may be sprayed first to first and second electrode plates 110 and 130 (hereinafter, referred to as electrode plates). The adhesive solution may include any solution having adhesive strength. The adhesive solution may be uniformly applied to at least one surface or both surfaces of the electrode plates 110 and 130. In some embodiments, the adhesive solution may be a polyolefin-based resin having viscosity of about 750 CPS to about 1,150 CPS (based on about 180 degrees Celsius). However, the above-described adhesive solution may be only an example, and any liquefied form capable of maintaining adhesive strength without being dissolved in the electrolyte may be used without limitation. In some embodiments, spraying of an adhesive into the liquefied form may minimize an increase in thickness of a stack cell by thinly applying the adhesive to the electrode plates 110 and 130. The adhesive solution may be sprayed to form an adhesive layer having a thinner thickness than that in a method for directly applying an adhesive tape or an adhesive.

If the adhesive solution is directly sprayed to the separator 150, the electrode plates 110 and 130 may be exposed, or a defective finish may occur due to folding of the separator 150 and curling and folding of the separator in a state of stacking the electrode plates. Therefore, to solve this limitation, in some embodiments, a method for spraying the adhesive solution to the electrode plates 110 and 130 instead of the separator 150 may be utilized.

If the spraying of the adhesive solution to the electrode plates 110 and 130 is completed, the separator 150 may be folded in a continuous ‘Z’ shape referring to FIG. 4. In some embodiments, the separator 150 may be folded in a zigzag form, and the first electrode plate 110 and the second electrode plate 130 may be alternately inserted between the folded portions. Arrow directions illustrated in FIG. 4 may indicate insertion directions of the first electrode plate 110 and the second electrode plate 130, respectively. If this stacking process is completed, the stack cell may be completed referring to FIG. 5. In some embodiments, the stack cell may be formed by alternately stacking a plurality of first electrode plates 110 and a plurality of second electrode plates 130 with the separators 150 therebetween.

The stack cell illustrated in FIG. 5 may be in close contact with the separator 150 by the adhesive solution sprayed to both surfaces of the first electrode plate 110 and the second electrode plate 130. Therefore, during the process of moving the stack cell or inserting the stack cell into the case, the stack cell may be maintained in the stacked state without being disturbed or collapsed. Therefore, stacking stability of the stack cell may be relatively improved.

According to some embodiments of the present disclosure, if the stack cell is manufactured, the adhesive solution may be sprayed to the electrode plate to prevent or reduce instances of the stack cell being disturbed or collapsed in aligned or stacked state. In some embodiments, the stacking stability of the stack cell may be relatively improved.

The above-mentioned embodiments is merely examples, and thus, embodiments according to the present invention are not limited to the foregoing embodiments, and also it will be understood by those of ordinary skill in the art that various changes in form and details may be made therein without departing from the spirit and scope of embodiments according to the present invention as defined by the following claims, and their equivalents.

What is claimed is:

1. A secondary battery comprising:
an electrode assembly comprising:
a plurality of first electrode plates and second electrode plates; and
a separator folded in a zigzag form and interposed between each of the first and second electrode plates; and
a case accommodating the electrode assembly,
wherein at least one surface of a first electrode plate from among the first electrode plates or a second electrode plate from among the second electrode plates adheres to the separator by an adhesive solution.

2. The secondary battery as claimed in claim 1, wherein the adhesive solution is sprayed to the at least one surface of the first electrode plate or the second electrode plate.

3. The secondary battery as claimed in claim 1, wherein the adhesive solution is sprayed to the at least one surface of each of the first electrode plate and the second electrode plate.

4. The secondary battery as claimed in claim 1, wherein the adhesive solution comprises a polyolefin-based resin.
